(19) United States
(12) Patent Application Publication
(10) Pub. No.: US 2014/0110579 A1
(43) Pub. Date: Apr. 24, 2014

(54) Handheld Spectrometer

(71) Applicant: Advanced Measurement Technology Inc., Oak Ridge, TN (US)

(72) Inventors: Joseph B. McCabe, Oak Ridge, TN (US); Frank Sergent, Knoxville, TN (US)

(73) Assignee: Advanced Measurement Technology Inc., Oak Ridge, TN (US)

(21) Appl. No.: 14/059,534

(22) Filed: Oct. 22, 2013

Related U.S. Application Data
(60) Provisional application No. 61/717,347, filed on Oct. 23, 2012.

(51) Int. Cl. G01T 1/16; G01T 7/00

(52) U.S. Cl. CPC G01T 1/16; G01T 7/00
USPC 250/336.1

(57) ABSTRACT

A lightweight handheld radiation detector for use in detecting radioactive materials, including a cylindrical vacuum housing having an inner volume, a detector material encasement disposed within the inner volume, a cooling element disposed within the inner volume and integrally formed with the detector material encasement to cool detector material within the detector material encasement.

### CROSS-REFERENCE TO RELATED APPLICATIONS

This application claims the benefit of U.S. Provisional Application No. 61/717,347 filed on Oct. 23, 2012.

### FIELD OF INVENTION

The present general inventive concept relates to a portable device to detect radiation and, more particularly, to an advanced discrete handheld spectrometer.

### BACKGROUND

Radioactive materials are typically unstable and emit radiation in the form of alpha, beta, gamma, or X-rays. Many different types of radiation detectors have been designed and manufactured to produce data corresponding to radioactive materials. One of the challenges of known devices is to provide a lightweight, portable, hand-held, radiation detector configured in size and shape to be discretely carried by a user. It has also been difficult to achieve a convenient germanium-based handheld radiation detector with a simple user interface to provide a user with a simple go, no-go approach to radiation detection, while enabling the device to selectively communicate with an external device, such as a PDA, to enhance field deployment opportunities and transmission of results-based information.

### BRIEF SUMMARY

Example embodiments of the present general inventive concept can also be achieved by providing a handheld radiation detector, including a cylindrical vacuum housing having an inner volume, a detector material encasement disposed within the inner volume, a cooling element disposed within the inner volume and integrally formed with the detector material encasement to cool detector material within the detector material encasement.

The handheld radiation detector may include a getter material disposed within the inner volume to capture or remove gases from the inner volume.

The handheld radiation detector may include a user interface to display a visual representation to a user indicating whether radiation was detected by the radiation detector. The visual representation may be a go/no-go indication such as a green light and/or red light.

The handheld radiation detector may include a communication port to communicate test results to an external device.

The handheld radiation detector may include a cylindrical heat pipe array connected to the cylindrical vacuum housing to pipe heat away from the vacuum housing, the cylindrical heat pipe array being substantially concentric to the cylindrical vacuum housing, thus defining a substantially cylindrical outer surface of the radiation detector.

The handheld radiation detector may include a laser scope to assist a user to target the radiation detector to a desired measurement location.

The handheld radiation detector may include a detector cap to house the detector material, getter material, and cooling element such that the cooling element is integrated with the detector material encasement within the detector cap.

The detector material encasement can be formed as an integral section of the cooling element such that an additional means of connection is not required to connect the detector material encasement and the cooling element within the inner volume.

The cylindrical outer surface of the radiation detector can be configured to be carried on a tool belt for a user.

The handheld radiation detector can be configured to weigh about five pounds or less.

Additional features and embodiments of the present general inventive concept will be set forth in part in the description that follows and, in part, will be obvious from the description, or may be learned by practice of the general inventive concept.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates an example of a handheld radiation detector device configured in accordance with an example embodiment of the present general inventive concept (upper portion of FIG. 1), wherein the inventive device is shown side-by-side with a conventional flashlight device known as Maglite® (lower portion of FIG. 1), for comparison purposes;

FIG. 2 is a cross-section view of a detector housing and cryo-stat volume configured in accordance with an example embodiment of the present general inventive concept, with the getter incorporated into the detector housing (vacuum);

FIG. 3 illustrates a traditional getter configuration incorporated externally of the radiation detector housing;

FIG. 4 illustrates a view similar to FIG. 2, showing a combined detector encasement and cooling element configured in accordance with an example embodiment of the present general inventive concept;

FIG. 5 is a cross-section view of the example embodiment illustrated in FIG. 1;

FIG. 6 is a perspective view of a detector encasement configured in accordance with an example embodiment of the present general inventive concept;

FIGS. 7 and 8 are perspective views of a detector (vacuum) housing end cap to enclose the detector encasement, cooler element, and getter material to an end of the cylindrical detector device; and

FIG. 9 illustrates an example of the handheld radiation detector configured to be carried in a tool belt of a user.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

It is noted that although example embodiments are described herein in terms of high-purity germanium-based detectors, the present general inventive concept is not limited to germanium-based detectors, and may incorporate various alternative detector materials, without departing from the broader scope and content of the present general inventive concept.

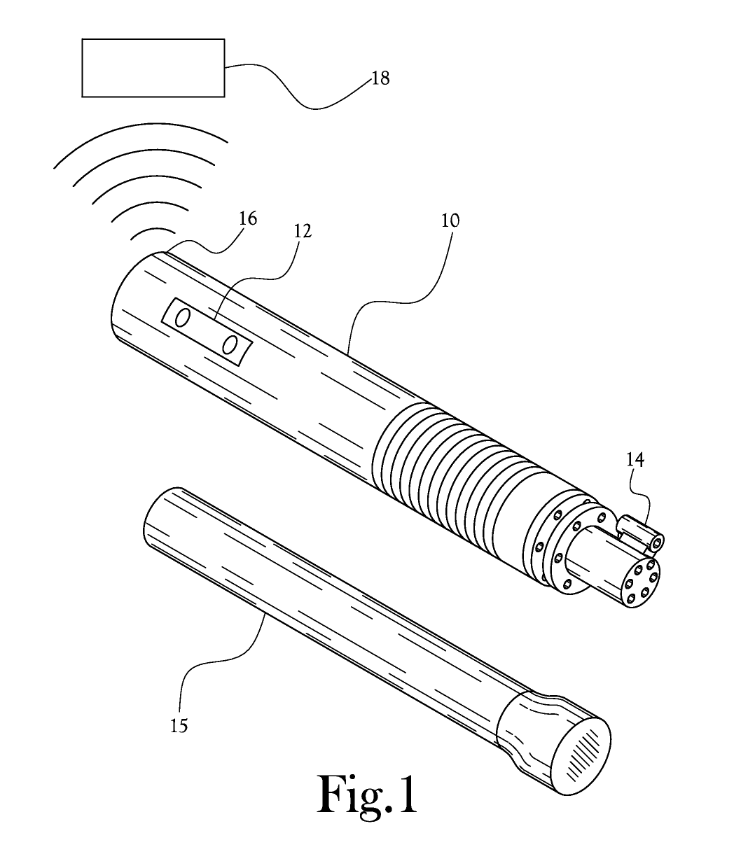

FIG. 1 illustrates an example of a handheld radiation detector 10 configured in accordance with an example embodiment of the present general inventive concept (upper portion of FIG. 1). The embodiment is shown side-by-side with a conventional flashlight device 15, for example those known as a Maglite®, which is shown in the lower portion of FIG. 1. The side-by-side comparison is provided to illustrate the relative size, geometry, and discreteness of the inventive radiation detector 10. The relatively small design of the inventive radiation detector 10 enables the device to be easily carried by a user in the field. The relatively lightweight (e.g., around five pounds in some embodiments) and ergonomic design enables increased field use opportunities and deployment capability. In some embodiments, the device can be carried on a tool belt, etc. of a security or inspection official. The shape, size, weight, and discrete nature of the device is important to field deployed applications or any application where it is advantageous to have a device that is easily handled, transported, packaged, or used, and the size of the device is significantly smaller and lighter than what is currently available on the market. Referring to FIG. 1, the design of the advanced discrete spectrometer can embody a cylindrical shape to optimize field deployability.

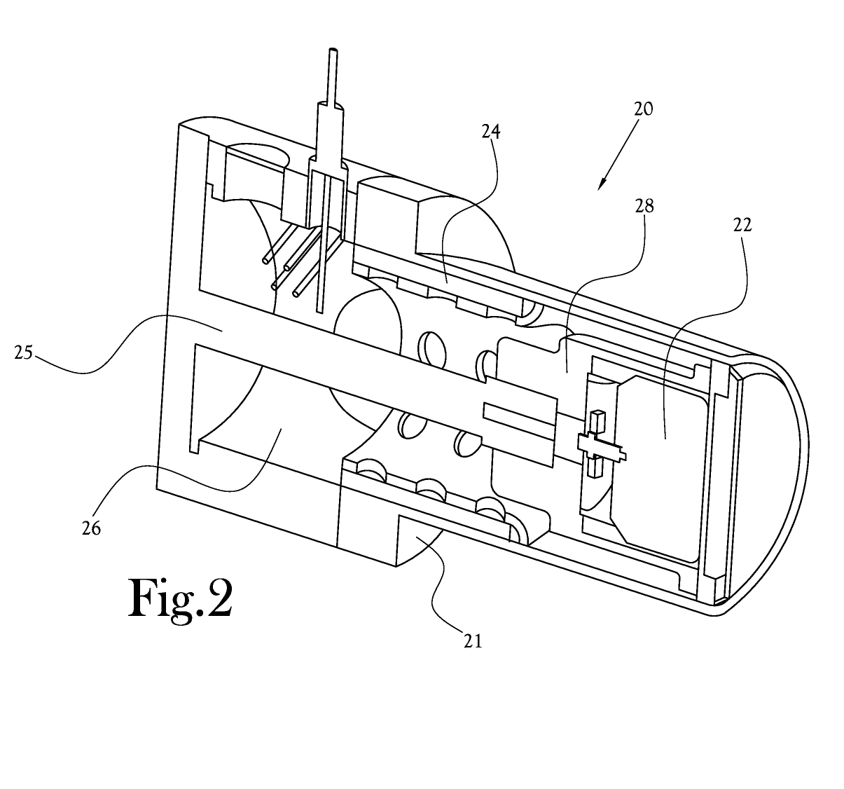

FIG. 2 is a cross-section view of a detector housing 20 and cryo-stat volume 26 configured in accordance with an example embodiment of the present general inventive concept. As illustrated in FIG. 2, the housing 20 includes getter material 24 incorporated into the detector housing (vacuum). Those skilled in the art will appreciate that a ‘getter’ represents a substance or device specifically introduced into a radiation detector to capture or remove off-gases.

As illustrated in FIG. 2, the getter material 24 is incorporated into available space in the detector housing (vacuum) to maintain the cylindrical outer body of the device. Integration of the high purity germanium crystal detector 22 or alternative material detector encasement with a getter of any variety of geometry or material. As illustrated in FIG. 2, the getter material 24 can be mounted inside the cryo-stat and/or housing of a high purity germanium crystal detector or alternative material detector encasement for optimized use of size or performance.

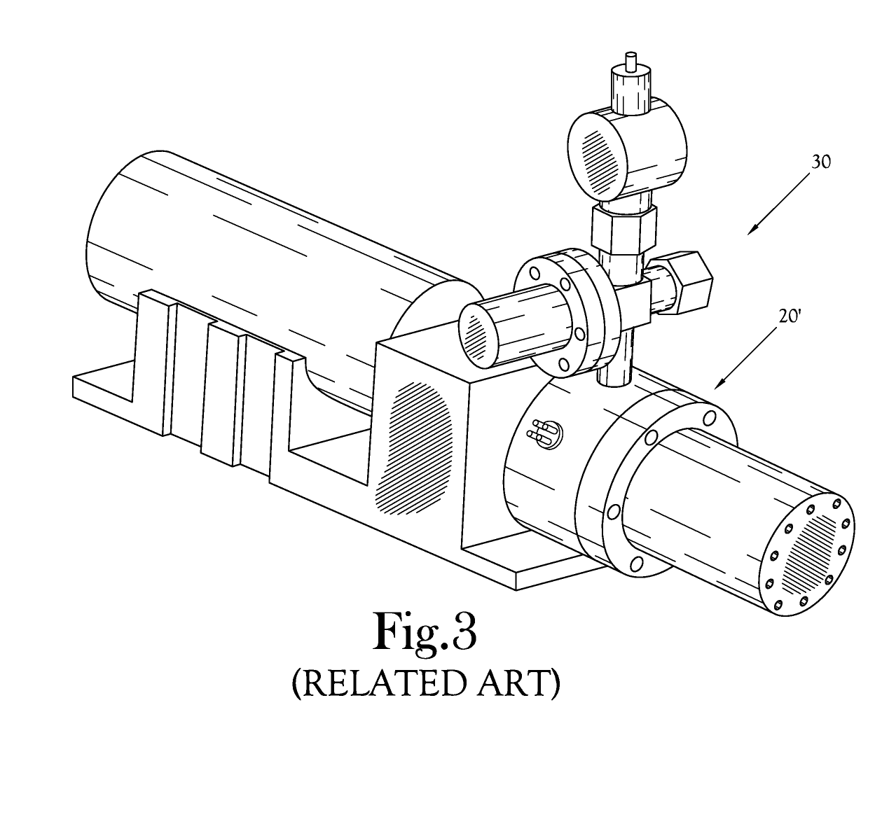

By comparison, FIG. 3 illustrates a traditional getter configuration wherein the getter apparatus 30 protrudes from the outer body of the detector housing 20′. One of the disadvantages of this traditional design is that the getter apparatus 30, which is located on an outside surface of the detector housing 20′, creates an increased footprint for the device, which interferes with the streamlined design, portability, packaging, and carrying of the device.

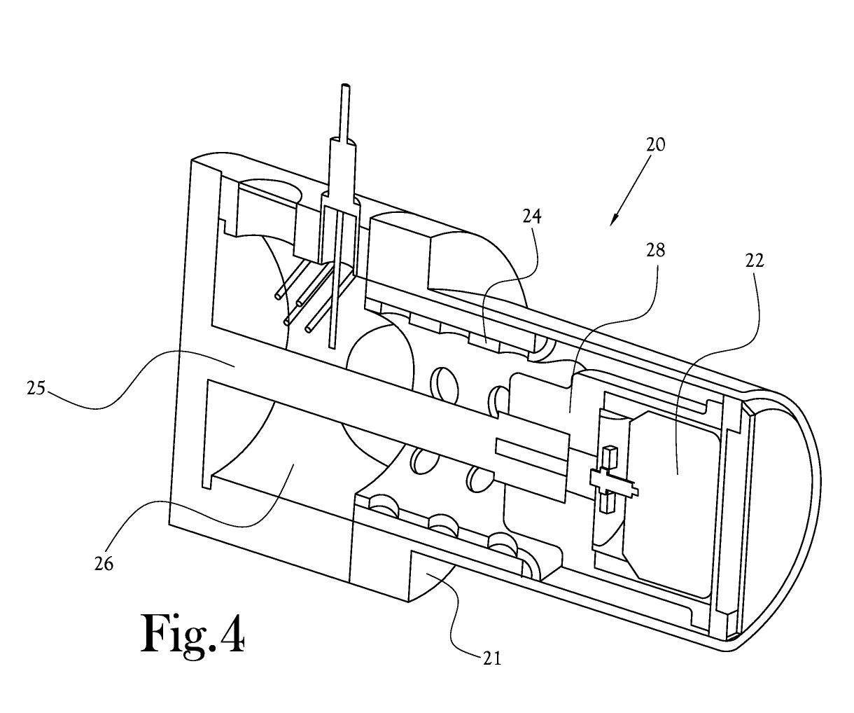

FIG. 4 illustrates a view similar to FIG. 2, showing a combined detector encasement and cooling element 25, or cold tip, configured in accordance with an example embodiment of the present general inventive concept. In FIG. 4, the cooling element 25 is integrated with the detector encasement 28 within the outer detector cap housing the detector 22, getter material 24, and cooling element 25. By integrating the cooling element 25 with the detector encasement 28, fewer parts are required, less cooling losses are encountered, and increased miniaturization is achieved. Moreover, with fewer parts taking up less space within the detector cap, it is possible to expand the size of the detector material crystal to increase detectability of the device. It is possible to provide different amounts of detector material, and customize respective cooling elements, to provide various ranges of detection capability.

One of the differences between the present design and prior known designs is that the detector material, such as high purity germanium, is housed in an encasement that is a section of the cooling device itself, and does not require a mechanical means of connection. Enclosing the detector in the cooling device reduces the heat path between the detector and cooling device and improves cooling capability and efficiency.

For example, suppose that an operational temperature in range of 77K to 110K should be maintained for proper operation of the device. The more efficient the device is at cooling the detector, the smaller the cooler can be and subsequently the less power the cooler will consume. This provides benefits to the user in the form of smaller overall geometry and longer operational life. The cooling efficiency of the device is related to minimization of heat paths to the detector and maximization of heat conduction from the detector. Referring to FIG. 4, there is illustrated the detector encasement being integrated into the cooler itself, with results being the conduction path between the detector and cooler is shortened.

In some embodiments, the cooler device may be of the stirling, kleemenko, etc., and high purity germanium crystal detector casement or alternative material detector casement is integrated with the sterling or alternative style cooler or cooling device. The device may include a cooling device that is customized for a particular application.

In some embodiments, the device may incorporate a laser scope 14 to assist the user to more accurately target desired measurement locations. The laser scope 14 may be located on an outer surface of the detector cap, or on other locations of the detector chosen with sound engineering judgment, to assist the user to aim the detector.

FIG. 5 is a cross-section view of an example embodiment of the present general inventive concept. To address heat removal from the cooler, it is possible to embody a heat dissipation array 50 to pipe heat away from areas of concern. FIG. 5 illustrates an example configuration of an optional heat pipe array integrated with the cooler/cryostat within the detector housing 20.

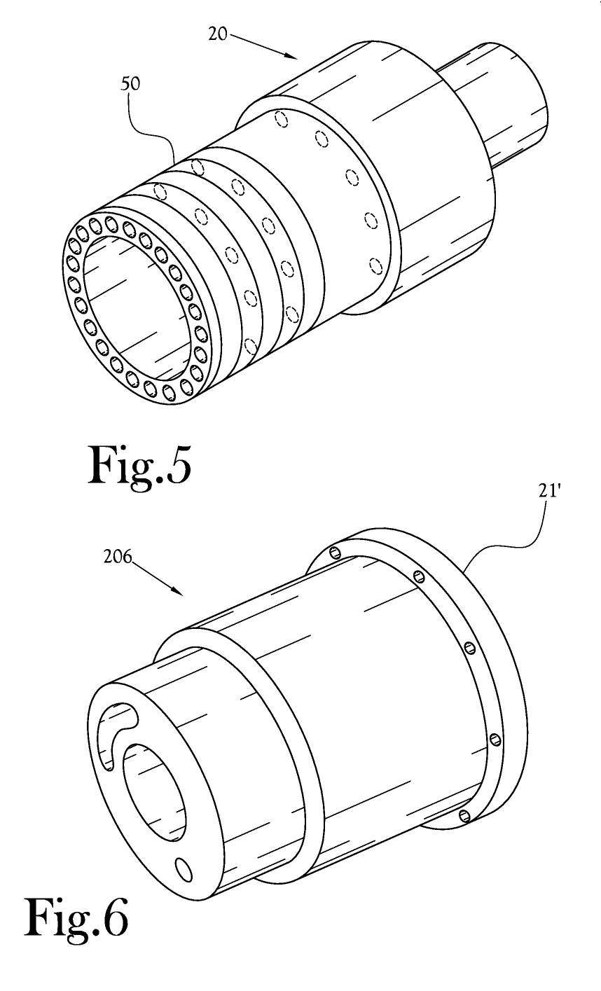

FIG. 6 is a perspective view of a detector encasement 206 configured in accordance with an example embodiment of the present general inventive concept.

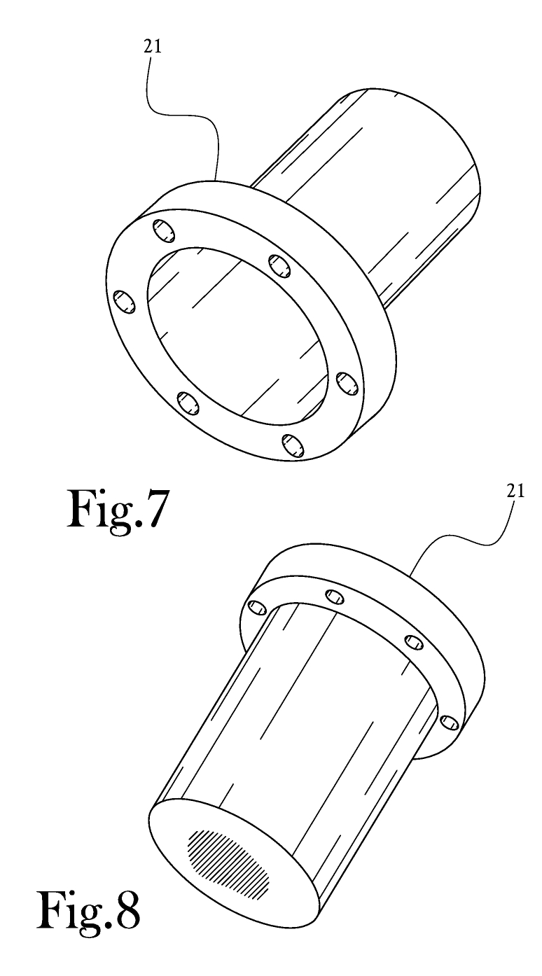

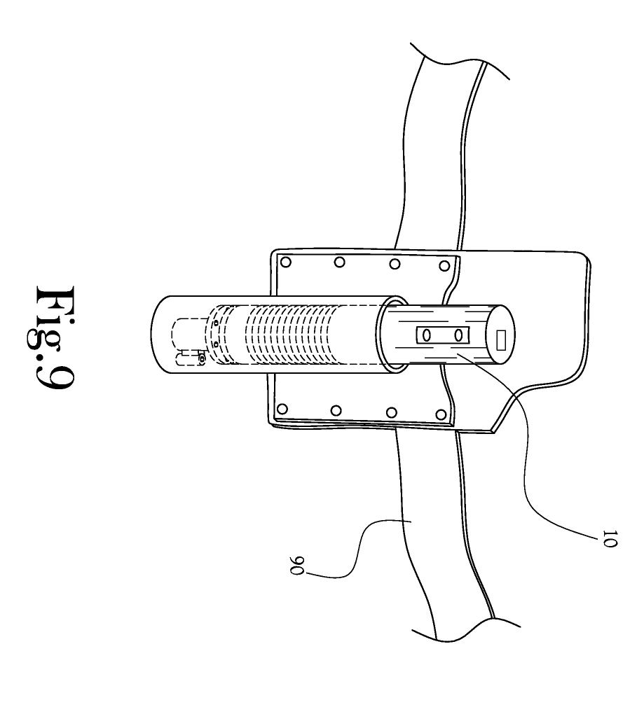

FIGS. 7 and 8 are perspective views of a detector housing end cap 21 to enclose the detector encasement, cooler element, and getter material to an end of the cylindrical detector device.

As illustrated and described herein, the device may incorporate snap fit joints into the design, as opposed to traditional fasteners, to enhance manufacturability and reduce the total mass of device. Various types of snap fits may be used. For example, the device may include quick access battery components that may include snap fit joints, including but not limited to a simple plug-in for charging of the battery. It is possible to provide multiple battery options with different ranges of battery life.

FIG. 9 illustrates an example of the handheld radiation detector configured to be carried in a tool belt 90 of a user, demonstrating the relatively small design of the radiation detector 10. The device is configurable to enable the device to be easily carried by a user in the field, and the relatively lightweight (e.g., around five pounds in some embodiments) and ergonomic design enables increased field use opportunities and deployment capability.

Embodiments of the present general inventive concept also provide a simple user interface 12 to provide a user with a simple go, no-go approach to radiation detection. For example, referring again to FIG. 1, the device can include a simple user interface 12 with a ‘green-light, red-light’ go, no-go concept, to make the device simple and quick to use in the field. In some embodiments, in the event that a detection is made, the device may be instructed, by user command or other predetermined instruction, to communicate more detailed information about the nature of the detection via wired or wireless communications to an external device 18. For example, the device may communicate via a communication port 16, such as a Bluetooth and/or internet connection, with an external device 18 such as a personal data assistant (PDA), cell phone, computer, or other known or later developed devices in order to communicate information about the detection (e.g., type of material detected, quantity of material detected, location, etc.) to one or more external devices, whether the external device(s) is carried by a user or stationed at another location. For example, it is also possible to transmit test data between multiple external devices to make information available to multiple parties. This enables the device to selectively communicate with external devices to enhance field deployment opportunities and transmit results-based information.

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

The present general inventive concept can be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, flash memory, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While the present general inventive concept has been illustrated by description of several example embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

1. A handheld radiation detector, comprising:
a cylindrical vacuum housing having an inner volume:
a detector material encasement disposed within the inner volume; and
a cooling element disposed within the inner volume and integrally formed with the detector material encasement to cool detector material within the detector material encasement.

2. The handheld radiation detector of claim 1, further comprising:
a getter material disposed within the inner volume to capture or remove gases from the inner volume.

3. The handheld radiation detector of claim 1, further comprising:
a user interface to display a visual representation to a user indicating whether radiation was detected by the radiation detector.

4. The handheld radiation detector of claim 3, wherein the visual representation is a green light and/or red light.

5. The handheld radiation detector of claim 1, further comprising:
a communication port to communicate test results to an external device.

6. The handheld radiation detector of claim 1, further comprising:
a cylindrical heat pipe array connected to the cylindrical vacuum housing to pipe heat away from the vacuum housing, the cylindrical heat pipe array being substantially concentric to the cylindrical vacuum housing, thus defining a substantially cylindrical outer surface of the radiation detector.

7. The handheld radiation detector of claim 1, further comprising:
a laser scope to assist a user to target the radiation detector to a desired measurement location.

8. The handheld radiation detector of claim 2, further comprising:
a detector cap to house the detector material, getter material, and cooling element such that the cooling element is integrated with the detector material encasement within the detector cap.

9. The handheld radiation detector of claim 1, wherein the detector material encasement is a section of the cooling element such that an additional means of connection is not required to connect the detector material encasement and the cooling element.

10. The handheld radiation detector of claim 6, wherein the cylindrical outer surface of the radiation detector is configured to be carried on a tool belt for a user.

11. The handheld radiation detector of claim 10, wherein the handheld radiation detector weighs about five pounds or less.
